(19) United States
(12) Patent Application Publication
(10) Pub. No.: US 2003/0193560 A1
(43) Pub. Date: Oct. 16, 2003

(54) Precise position control apparatus and precise position control method using the same

(75) Inventors: Jong-Han Oh, Suwon-City (KR); Min-Soo Kim, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon City (KR)

(21) Appl. No.: 10/211,531

(22) Filed: Aug. 5, 2002

(30) Foreign Application Priority Data
Apr. 10, 2002 (KR) 2002-19440

(51) Int. Cl. H04N 7/18

(52) U.S. Cl. 348/87; 348/95; 348/136

(57) ABSTRACT

A precise position control apparatus and precise position control method using the same includes a control unit to control an amount of movement of a moving object, an optical system to photograph the moving object and to generate an image signal, and a monitor to output the image signal onto its screen. The control unit measures an actual moving distance of the moving object and a number of pixels corresponding to the actual moving distance to calculate an actual distance for unit pixel appearing on the screen of the monitor. Additionally, the control unit controls the amount of movement of the moving object using the actual distance for unit pixel when the moving object is moved from one position to another.

### CROSS-REFERENCE TO RELATED APPLICATIONS

This application claims the benefit of Korean Application No. 2002-19440, filed Apr. 10, 2002, in the Korean Industrial Property Office, the disclosure of which is incorporated herein by reference.

### BACKGROUND OF THE INVENTION

1. Field of the Invention

The present invention relates generally to precise position control using optics, and more particularly, to a precise position control apparatus and precise control method using the same.

2. Description of the Related Art

Precise position control using optics has been applied in various ways to many industrial fields. Particularly, in a semiconductor manufacturing field, precise position control using optics is successfully utilized in an automatic wafer testing apparatus called “Prober”.

FIG. 1 is a view of a conventional automatic wafer testing apparatus. The automatic wafer testing apparatus is a device used to test an operation of a circuit on a wafer that is disposed on a stage. As shown in FIG. 1, a plurality of probing pins 104 are attached to a probing card 102 to be brought into contact with lands (not shown). The automatic wafer testing apparatus functions to allow the probing pins 104 to be positioned on the lands on a wafer 112 at a precision of less than 1 μm.

In the conventional automatic wafer testing apparatus, a camera 114 on a stage side and a camera 106 on a probing card side generate image information from opposite objects (e.g., the probing pins 104 and a wafer pattern of the wafer 12) of the automatic wafer testing apparatus. A control unit (not shown) obtains X, Y, and Z coordinates of the probing pins 104 and the wafer pattern from the image information, and moves a stage 110 along an X, Y and/or Z-axis to correct differences between the coordinates, thus achieving precise contact between the probing pins 104 and the lands.

In an optical system that is used to perform such precise position control, optical characteristics may easily vary based on a particular environment in which the position control is carried out. One of representative variations in the optical characteristics of the optical system is a variation in the characteristics of a lens of the optical system, which is caused by temperature, humidity, chemical composition of air in a chamber, etc. If the characteristics of the lens of the optical system vary, precise position control cannot be carried out. Accordingly, even while operations are carried out, an error caused by variations in optical characteristics of the optical system has to be corrected in order to carry out precise position control.

### SUMMARY OF THE INVENTION

Accordingly, it is an object of the present invention to provide a precise position control apparatus and precise position control method using the same, in which an actual distance for unit pixel is previously calculated, a total actual distance to move is calculated using a number of pixels, and a precise position control signal is generated.

Another object of the present invention is to provide a precise position control apparatus and precise position control method using the same, wherein an actual distance for unit pixel is frequently calculated during an operation, thereby correcting an error caused by variations in optical characteristics of an optical system so as to carry out precise position control.

Additional objects and advantages of the invention will be set forth in part in the description which follows and, in part, will be obvious from the description, or may be learned by practice of the invention.

The foregoing and other objects of the present invention are achieved by providing a precise position control apparatus including a control unit to control an amount of movement of a moving object, an optical system to photograph the moving object and to generate an image signal, and a monitor to output the image signal onto its screen. The control unit measures an actual moving distance of the moving object and a number of pixels corresponding to the actual moving distance to calculate an actual distance for unit pixel appearing on the screen of the monitor. The control unit also controls the amount of movement of the moving object using the actual distance for unit pixel when the moving object is moved from one position to another.

The foregoing and other objects of the present invention are achieved by providing a precise position control method using a precise position control apparatus. The precise position control apparatus includes a control unit to control an amount of movement of a moving object, an optical system to photograph the moving object and to generate an image signal, and a monitor to output the image signal onto its screen. The method includes measuring an actual moving distance of the moving object and a number of pixels corresponding to the actual moving distance in order to calculate an actual distance for unit pixel appearing on the screen of the monitor. The method also includes controlling the amount of movement of the moving object using the actual distance for unit pixel when the moving object is moved from one position to another.

### BRIEF DESCRIPTION OF THE DRAWINGS

The above and other objects and advantages of the invention will become apparent and more appreciated from the following description of the preferred embodiments, taken in conjunction with the accompanying drawings of which:

FIG. 1 is a view of a conventional automatic wafer testing apparatus;

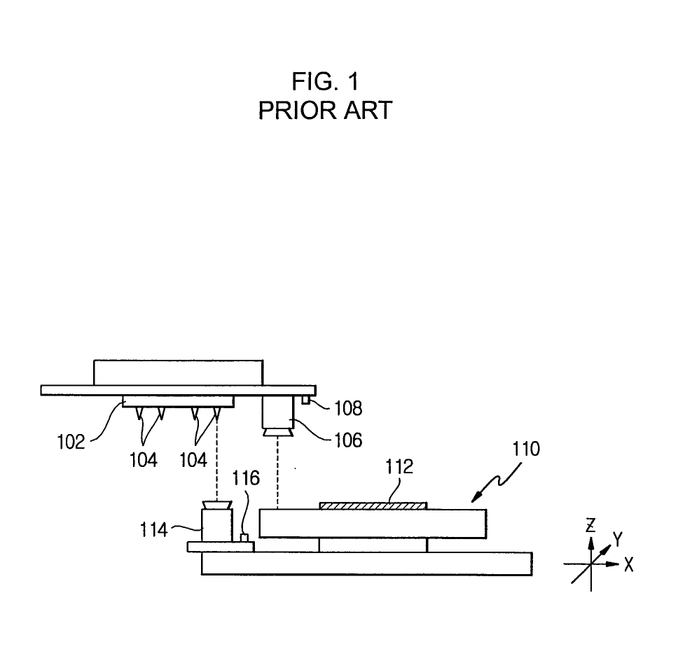

FIG. 2 is a block diagram of a precise position control apparatus, according to an embodiment of the present invention;

FIG. 3 is a flowchart of a precise position control method using the precise position control apparatus in FIG. 2;

FIG. 4A is a flowchart showing a coordinate axis coincidence process of the precise position control method;

FIG. 4B is a view showing the principle of the coordinate axes coincidence process;

FIG. 5A is a flowchart showing a process of obtaining an actual distance for unit pixel that pertains to the precise position control method;

FIG. 5B is a flowchart showing a principle of the process of obtaining the actual distance for unit pixel; and

FIG. 6 is a flowchart showing actual position control using the precise position control method.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

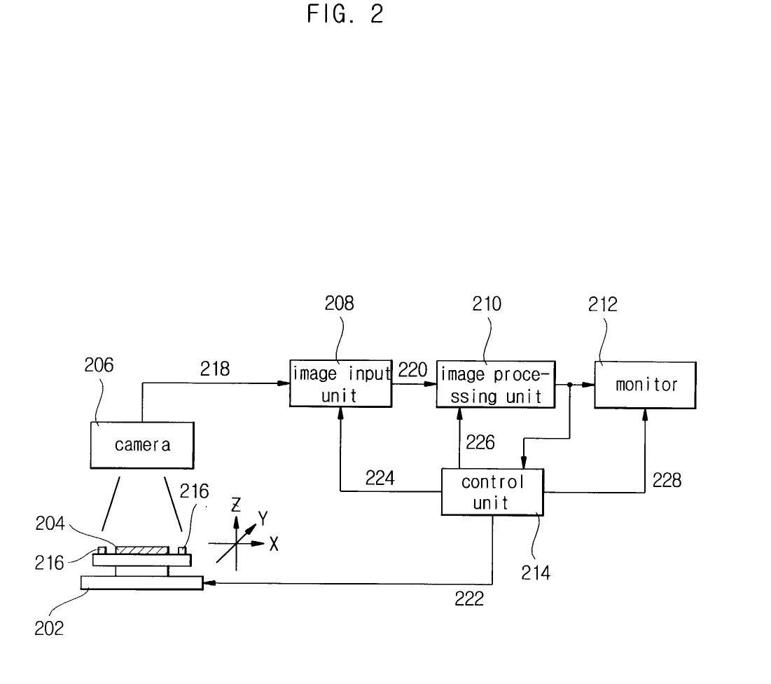

FIG. 2 is a block diagram of a precise position control apparatus. As shown in FIG. 2, a reference pattern 216 is formed on a stage 202, on which a subject 204 such as a wafer is placed to perform an arrangement of a wafer and a coincidence of coordinate axes. A camera 206 photographs a top of the stage 202 to generate an analog image signal 218. An image input unit 208 converts the analog image signal 218 generated in the camera 206 into a digital image signal 220, and transmits the digital image signal 220 to an image processing unit 210. The image processing unit 210 processes the digital image signal 220 using a digital signal processor or central processing unit, and outputs a processed signal to a monitor 212. A control unit 214 generates a stage control signal 222, an image input unit control signal 224, an image processing unit control signal 226, and a monitor control signal 228 to control its component parts. The stage 202 is moved along X, Y and Z-axes in response to the stage control signal 222 from the control unit 202. The reference pattern 216 formed on the stage 202 allows the axes of the stage 202 to coincide with axes on the screen of the monitor 212. Additionally, the reference pattern 216 allows a subject to be situated on a certain region of the screen of the monitor 212.

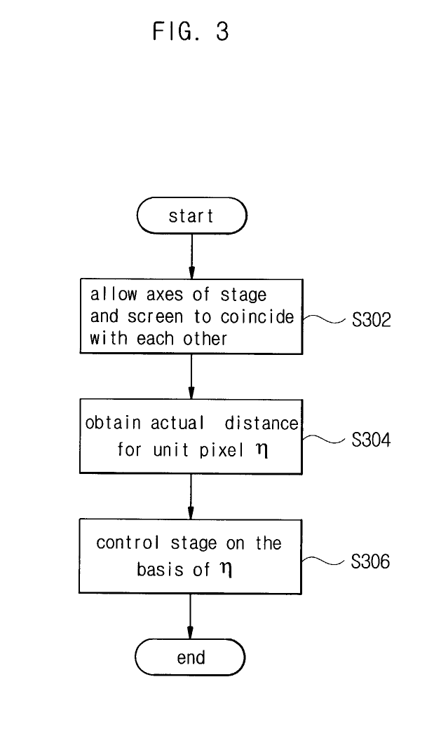

FIG. 3 is a flowchart of a precise position control method using the precise position control apparatus in FIG. 2 according to the present invention. The reference numerals of the elements shown in FIG. 2 are used to describe FIG. 3. As shown in FIG. 3, the coincidence of coordinate axes is performed so as to allow coordinate axes of the stage 202 to coincide with coordinate axes of the screen of the monitor 212 at operation S302. After the coincidence is performed, an actual distance for unit pixel η is obtained at operation S304. The actual distance for unit pixel η is an actual distance on the stage 202 that corresponds to a distance of a single pixel on the screen of the monitor 212. After the actual distance for unit pixel η is obtained, the stage control signal 222 is generated to control the movement of the stage 202 using the actual distance for unit pixel η at operation S304. When the stage 202 has to be moved a certain distance, a decision is made by the control unit 214 to determine a number of pixels that correspond to the certain distance by using image information outputted from the monitor 212 (see operation S306). The certain distance is obtained by multiplying the actual distance for unit pixel η by the number of pixels. The stage control signal 222 is generated by the control unit 214 to move the stage 202 in accordance with the certain distance.

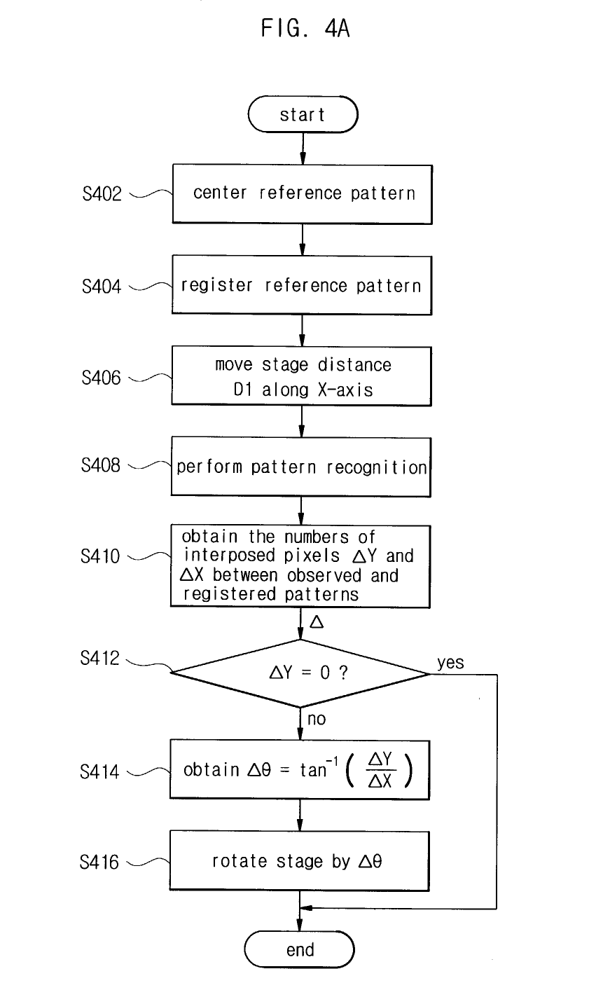

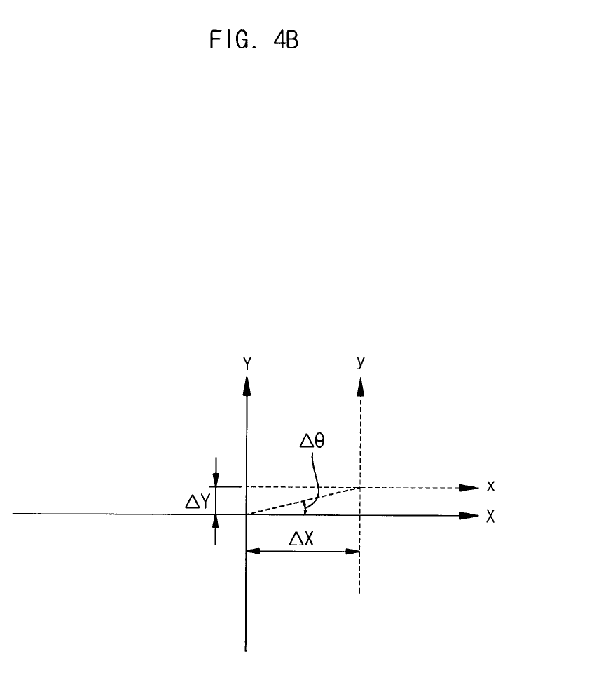

FIG. 4A is a flowchart showing a coordinate axis coincidence process of the precise position control method of the present invention. The coordinate axes of the screen of the monitor 212 are allowed to coincide with the coordinate axes of the stage 202 by the coordinate axes coincidence process. The reference numerals of the elements shown in FIG. 2 are used to describe FIG. 4A. As shown in FIG. 4A, the stage 202 is adjusted to position the reference pattern 216 at the center of the screen of the monitor 212 at operation S402. The reference pattern 216, at a current position, is registered in the control unit 214 (see operation S404). The stage 202 is moved a certain distance D1 along an X-axis at operation S406, and pattern recognition is performed by comparing the registered reference pattern with the reference pattern 216 observed on the screen of the monitor 212 at operation S408. A number of interposed pixels ΔX and ΔY between the registered reference pattern and the observed reference pattern are obtained at operation S410. If the X-axis of the screen of the monitor 212 exactly coincides with the X-axis of the stage 202, a value of ΔY should be zero. If ΔY is not zero at operation S412, Δθ=tan⁻¹ (ΔY/ΔX) is obtained at operation S414.

FIG. 4B is a flowchart showing the principle of the coordinate axes coincidence process. If the coordinate axes of the screen of the monitor 212 do not coincide with the coordinate axes of the stage 202, the value of ΔY, as shown in FIG. 4B, is not zero. Thereafter, the axes of the screen of the monitor 212 are made to coincide with the axes of the stage 202 by obtaining Δθ=tan⁻¹ (ΔY/ΔX) and rotating the stage 202 by Δθ (see operation S416).

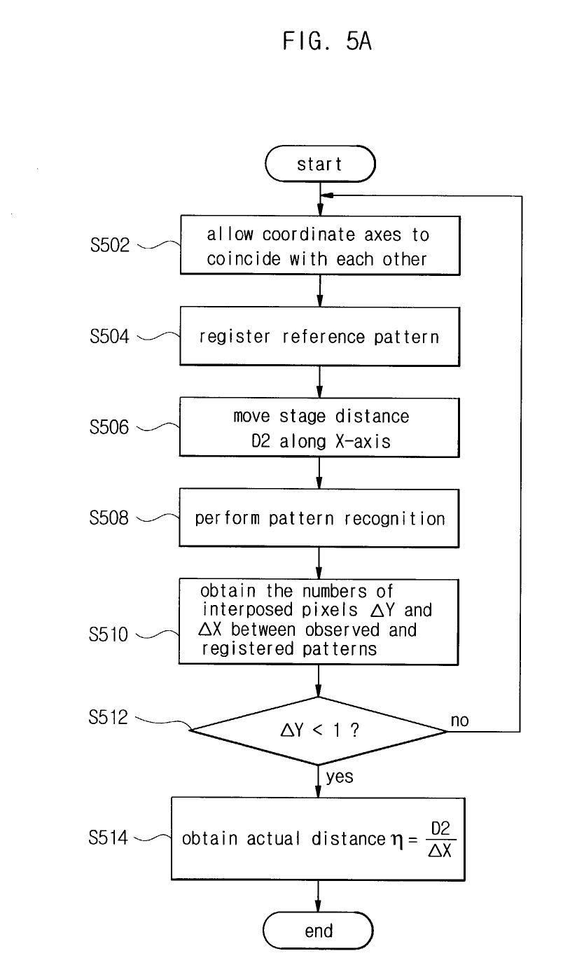

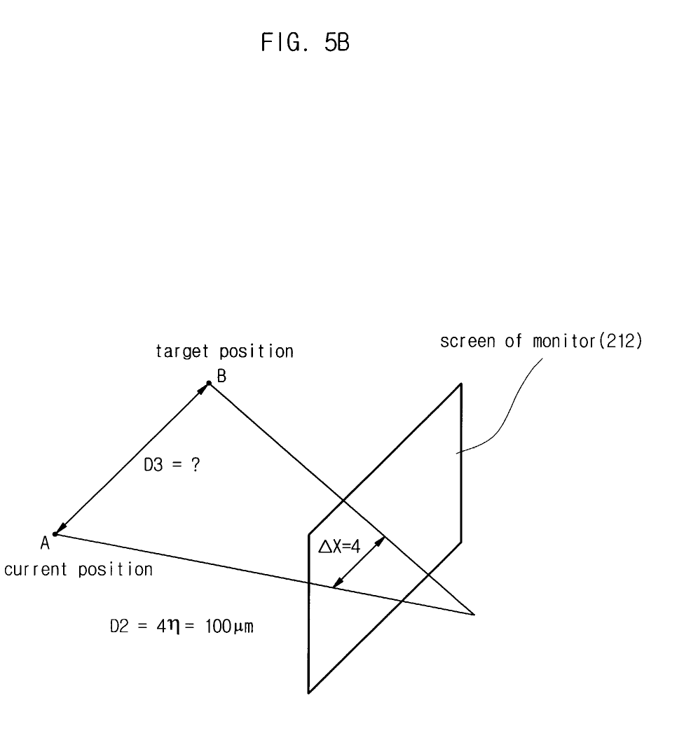

FIG. 5A is a flowchart showing a process of obtaining the actual distance for unit pixel that pertains to the precise position control method of the present invention. As mentioned above, the actual distance for unit pixel η is an actual distance that corresponds to a single pixel appearing on the screen of the monitor 212. The coordinate axes are allowed to coincide with each other by the method shown in FIG. 4A at operation S502. After the coincidence of the coordinate axes is performed, the reference pattern 216 is registered in the control unit 214 at operation S504. The stage 202 is moved a certain distance D2 along the X-axis at operation S506, and pattern recognition is performed by comparing the registered reference pattern with the reference pattern 216 observed on the screen of the monitor 212 at operation S508. A number of interposed pixels ΔX and ΔY between the registered and observed reference patterns are obtained at operation S510. The axes of the stage 202 are allowed to coincide with the axes of the screen of the monitor 212 at the coordinate axis coincidence operation S502 and the stage 202 is moved along the X-axis at the stage movement operation S506, so ΔY is zero. If ΔY is zero by an exact coincidence of the coordinate axes at operation S512, an actual distance η=D2/ΔX corresponding to a single pixel is calculated at operation S514. For example, when the moving distance of the stage 202 is 100 μm and the number of pixels on the screen of the monitor 212 corresponding to the moving distance is four, η=100 μm/4=25 μm.

The obtained η is used to calculate an actual distance in such a way as to multiply a number of differential pixels by the obtained η when a target position is known, but the actual distance from a current position to the target position is not known.

FIG. 5B is a view showing the principle of the process of obtaining the actual distance for unit pixel. As shown in FIG. 5B, when a current position of the stage 202 is “A” and a target position of the stage 202 is “B”, an actual distance D3 between the positions “A” and “B” is not known. Thus, an exact value cannot be generated to control the stage 202. However, the actual distance D3 is easily obtained by multiplying the obtained T1 by the number of interposed pixels appearing on the screen of the monitor 212.

As described above, in the precise position control method, although variations in the optical characters of the optical system occur, a total actual distance is precisely calculated using the actual distance for unit pixel, thereby compensating for the variations. The process of obtaining the actual distance for unit pixel may be carried out during an operation so that the variations are compensated for during the operation.

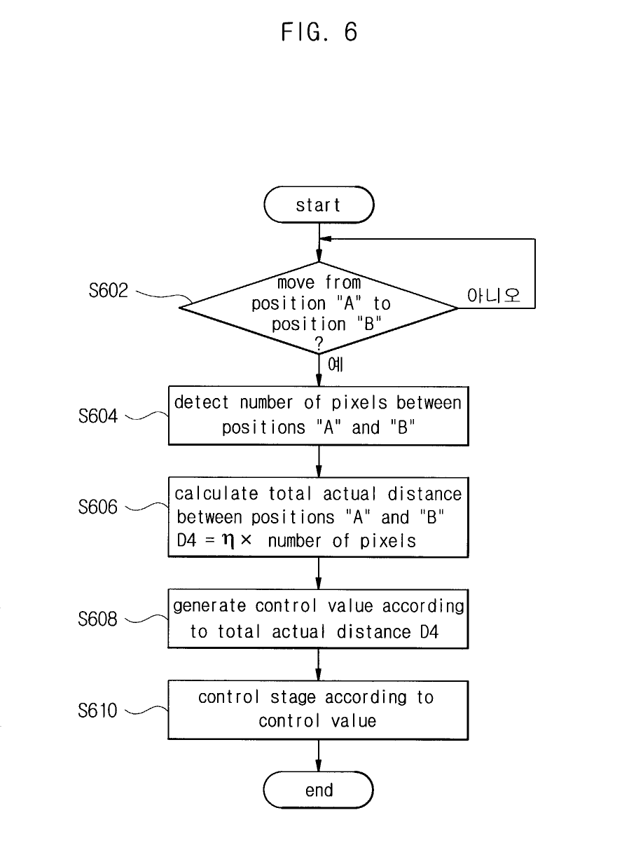

FIG. 6 is a flowchart showing actual position control using the precise position control method of the present invention. As shown in FIG. 6, if an object is moved from position “A” to position “B” at operation S602, the number of pixels interposed between the positions “A” and “B” is detected at operation S604. The total actual distance D4 is calculated using the detected number of pixels and the actual distance for unit pixel η at operation S606. After the total actual distance D4 is obtained, a control value corresponding to the total actual distance D4 is generated to control the stage 202 at operation S608 and S610.

As described above, if the process of obtaining the actual distance for unit pixel is performed during an operation, an actual distance to move the stage may be precisely calculated. For example, if a distance outputted onto the screen of the monitor is greater than usual due to variations in the optical characteristics of the optical system, the actual distance for unit pixel is calculated to be shorter. However, the total actual distance is calculated using the actual distance for unit pixel to compensate for the variations.

As described above, the present invention provides a precise position control apparatus and precise position control method using the same, in which the actual distance η for unit pixel is previously calculated and applied to precise position control. Thus, variations in the optical characteristics of the optical system are compensated for, thereby performing precise position control. Additionally, the compensation for variations may be carried out during an operation without requiring use of an additional device to carry out the compensation and increase cost.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A precise position control apparatus, comprising:
a control unit to control an amount of movement of a moving object;
an optical system to photograph the moving object and to generate an image signal; and
a monitor to output the image signal onto a screen thereof,
wherein the control unit measures an actual moving distance of the moving object and a number of pixels corresponding to the actual moving distance to calculate an actual distance for unit pixel appearing on the screen of the monitor, and controls the amount of movement of the moving object using the actual distance for unit pixel when the moving object is moved from one position to another.

2. A precise position control method using a precise position control apparatus, the precise position control apparatus having a control unit to control an amount of movement of a moving object, an optical system to photograph the moving object and to generate an image signal, and a monitor to output the image signal onto a screen thereof, the method comprising:
measuring an actual moving distance of the moving object and a number of pixels corresponding to the actual moving distance to calculate an actual distance for unit pixel appearing on the screen of the monitor; and
controlling the amount of movement of the moving object using the actual distance for unit pixel when the moving object is moved from one position to another.

3. The precise position control method according to claim 2, wherein the calculating of the actual distance for unit pixel comprises:
centering a reference pattern formed on the moving object at a center of the screen of the monitor, and registering the reference pattern; and
calculating a number of interposed pixels of ΔX and ΔY between the registered reference pattern and an observed reference pattern to allow coordinate axes of the screen of the monitor to coincide with the coordinate axes of a stage on which the moving object is placed.

4. The precise position control method according to claim 3, wherein, when the coordinate axes of the screen of the monitor and the coordinate axes of the stage do not coincide with the each other, Δθ=tan⁻¹ (ΔY/ΔX) is calculated and the stage is rotated by Δθ to allow coordinate axes of the screen of the monitor to coincide with the coordinate axes of the stage.

5. An apparatus to compensate for variations in characteristics of an optical system, comprising:
a control unit to control an amount of movement of a moving object;
an optical system to photograph the moving object and to generate an image signal; and
a monitor to output the image signal onto a screen thereof,
wherein the control unit measures an actual moving distance of the moving object and a number of pixels corresponding to the actual moving distance to calculate an actual distance for unit pixel appearing on the screen of the monitor, and compensates for variations in optical characteristics of the optical system by controlling the amount of movement of the moving object using the actual distance for unit pixel.

6. A method of compensating for variations in characteristics of an optical system using a precise precision control apparatus, the precise position control apparatus having a control unit to control an amount of movement of a moving object, an optical system to photograph the moving object and to generate an image signal, and a monitor to output the image signal onto a screen thereof, the method comprising:
measuring an actual moving distance of the moving object and a number of pixels corresponding to the actual moving distance to calculate an actual distance for unit pixel appearing on the screen of the monitor; and
compensating variations in optical characteristics of the optical system by controlling the amount of movement of the moving object using the actual distance for unit pixel.

7. The method according to claim 6, wherein the calculating of the actual distance for unit pixel comprises:
centering a reference pattern formed on the moving object at a center of the screen of the monitor, and registering the reference pattern; and
calculating a number of interposed pixels of ΔX and ΔY between the registered reference pattern and an observed reference pattern to allow coordinate axes of the screen of the monitor to coincide with the coordinate axes of a stage on which the moving object is placed.

8. The precise position control method according to claim 7, wherein, when the coordinate axes of the screen of the monitor and the coordinate axes of the stage do not coincide with the each other, Δθ=tan⁻¹ (ΔY/ΔX) is calculated and the stage is rotated by Δθ to allow coordinate axes of the screen of the monitor to coincide with the coordinate axes of the stage.

9. The method according to claim 6, wherein the compensating of variations in optical characteristics of the optical system is performed before the moving object is moved, and the actual distance for unit pixel is used to calculate the amount of movement of the moving object.
